(19) United States
(12) Patent Application Publication
(10) Pub. No.: US 2026/0236979 A1
(43) Pub. Date: Aug. 13, 2026

(54) METHOD FOR DETECTING CLOTHING CONTENT PARTICULARLY TO SUPPORT RECYCLING AND WASHING AND A SYSTEM IMPLEMENTING THE SAME

(71) Applicant: Neslihan BAYAV, Ordu (TR)

(72) Inventor: Neslihan BAYAV, Ordu (TR)

(21) Appl. No.: 19/517,831

(22) PCT Filed: May 29, 2024
(86) PCT No.: PCT/TR2024/050564

§ 371 Date: Mar. 10, 2026

(30) Foreign Application Priority Data
May 29, 2023 (TR) 2023/006180

(51) Int. Cl. G06Q 30/0601; D06F 34/28; G06F 16/9536; G06Q 10/30

(52) U.S. Cl. CPC G06Q 30/06313; D06F 34/28; G06F 16/9536; G06Q 10/30

(57) ABSTRACT

Provided is a method performed by a system with a user terminal consisting of a label sensor that detects the labels of the objects and produces a corresponding label signal, a camera capturing the images of the objects, and a processor unit that receives the signal from the said camera and the label sensor in order to detect the contents of the objects, which are clothing, textile products and garments.

### CROSS REFERENCE TO THE RELATED APPLICATIONS

This application is the national phase entry of International Application No. PCT/TR 2024/050564, filed on May 29, 2024, which is based upon and claims priority to Turkish Patent Application No. 2023/006180, filed on May 29, 2023, the entire contents of which are incorporated herein by reference.

### TECHNICAL FIELD

The invention relates to a method performed by a system with a user terminal consisting of a label sensor that detects the labels of the objects and produces a corresponding label signal, a camera for capturing the images of the objects, and a processor unit that receives the signal from the said camera and label sensor in order to detect the contents of objects, which are clothing, textile products and garments.

### BACKGROUND

Clothing is made from a variety of materials, each with unique properties and care requirements. The identification of these materials is necessary for a variety of purposes, such as recycling, washing, dyeing, selling, buying, and donating. Accurate identification of clothing materials ensures that proper care and handling methods are applied, thus extending the life of the clothing and promoting sustainability.

In the state of art, there are several methods for identifying the contents of clothing. The most common method is the use of labels, which are usually sewn or attached to clothing. These labels provide fabric composition, care instructions, and other relevant information. Labels can contain textual information or be encoded with readable technology such as QR codes or RFID chips.

However, a significant limitation of existing methods is that the labels can be easily removed or damaged. When the label is lost or becomes unreadable, it becomes difficult to accurately determine the material composition of the clothing. This is particularly problematic in recycling processes, when different materials need to be sorted and properly processed, or in laundry services, where improper washing procedures can damage the fabric.

Therefore, the need for an advanced method is obvious which accurately identifies the material content of clothing and relies not only on removable or delicate labels. Such a method ensures that the material composition can always be determined, regardless of the condition or presence of the original labels. This will make it easier for clothes to be washed, recycled, dyed, sold, bought, and donated correctly, ultimately contributing to better clothing care and sustainable practices in the fashion and textile industries.

Washing machines are currently the definitive solution for cleaning and maintenance management for clothing and textiles.

The wastefulness of existing washing machines can also be attributed to the determination process of wash cycles. Today, washing machines clean clothing and textiles according to the strict program which takes into account the water temperature, the number of cycles and the duration arbitrarily adjusted according to the type of clothing/textile fabric material. However, the load size, chemical/physical properties of the water and other key variables associated with washing machines are not taken into account. Additionally, recent reports suggest that washing programs based on the type of existing clothing/textile fabric material used by the majority of existing washing machines should not be seen as doctrine or mandatory, as some clothing/textile items can be cleaned at a much lower temperature, with fewer cycles, and less volume of water. Therefore, the determination process for wash cycles should be reviewed and improved, and there must be a shift from the current wasteful arbitrary approach to more precise, accurate and individualized determination approach adopted in a piecemeal way or at an individual level. One of the most promising approaches that can help washing machines select the most precise and accurate washing program is the use of the latest advances in artificial intelligence and data collection technologies. To date, there is only one patent describing the use of artificial intelligence in washing machines, but this patent only uses data-derived clothing/textiles tagged with RFID tags that store data on the properties of clothing/textile materials. However, this patent does not provide solutions for non-RFID-tagged clothing/textile products. In addition, this patent does not describe solutions for washing machines that are not wirelessly connected. In addition, this patent recommends the use of only water and detergent for washing clothing/textiles.

In addition, the waste caused by the use of the textile and clothing industry or any type of article that can be purchased or manufactured or that is natural is not limited to the use of existing cleaning, washing and maintenance methods. In fact, wastefulness from waste from the use of textiles and garments or purchasable or manufactured or natural products contributes to the growing global waste management problem. Already used or second-hand items either end up in landfills or are burned in incinerators, causing environmental pollution and destruction. Only a very small amount of used or second-hand items are recycled. For example, in the UK, only 1% of all used or second-hand clothing or textiles are recycled. Unfortunately, this harmful phenomenon is largely due to a lack of knowledge or access to easy, effective and practical solutions for managing this type of waste. Currently, there are commercially available online websites or Apps that offer resale options for used or second-hand clothing or textiles or natural products that can be purchased or manufactured. However, these websites or Apps suffers from several limitations and drawbacks, including authentication issues, time-of-use consumption, cumbersome manual entry, and much more. In addition, there is currently no fit-for-purpose, one-stop-shop, preferably online App for reselling, recycling or even donating used or second-hand items.

The present application describes the methods, processes, hardware, software and apparatus for the management of the maintenance, cleaning, washing, recycling, selling, reselling, donation and redyeing of clothing and textile items or purchasable or natural or manufactured products, including products, assemblies, parts and others. The methods, processes, hardware, software and apparatus of the present application are designed to manage the maintenance, cleaning, washing, recycling, selling, reselling, donation and redyeing of clothing and textile items or purchasable or manufactured products with smart, cost-effective and environmentally friendly approaches by using the latest advances in artificial intelligence and software engineering, application development and image processing technologies, materials science and cleaning methods including but not limited to UV, laser, ozone, softeners and others.

In addition, the waste caused by the use of the textile and clothing industry or any type of items that can be purchased or manufactured or that is natural is not limited to the use of existing cleaning, washing and maintenance methods. In fact, wastefulness from waste from the use of textiles and garments or purchasable or manufactured or natural products contributes to the growing global waste management problem. Already used or second-hand items either end up in landfills or are burned in incinerators, causing environmental pollution and destruction. Only a very small amount of used or second-hand items are recycled. For example, in the UK, only 1% of all used or second-hand clothing or textiles are recycled. Unfortunately, this harmful phenomenon is largely due to a lack of knowledge or access to easy, effective and practical solutions for managing this type of waste. Currently, there are commercially available online websites or Apps that offer resale options for used or second-hand clothing or textiles or natural products that can be purchased or manufactured. However, these websites or Apps suffers from several limitations and drawbacks, including authentication issues, time-of-use consumption, cumbersome manual entry, and much more. In addition, there is currently no fit-for-purpose, one-stop-shop, preferably online App for reselling, recycling or even donating used or second-hand items.

The present application describes the methods, processes, hardware, software and apparatus for the management of the maintenance, cleaning, washing, recycling, selling, reselling, donation and redyeing of clothing and textile items or purchasable or natural or manufactured products, including products, assemblies, parts and others. The methods, processes, hardware, software and apparatus of the present application are designed to manage the maintenance, cleaning, washing, recycling, selling, reselling, donation and redyeing of clothing and textile items or purchasable or manufactured products with smart, cost-effective and environmentally friendly approaches by using the latest advances in artificial intelligence and software engineering, application development and image processing technologies, materials science and cleaning methods including but not limited to UV, laser, ozone, softeners and others.

In addition to all these, companies are trying to achieve net zero emissions by calculating the carbon footprint caused by their products. When products are recycled by consumers, it is not possible to accurately calculate the additional carbon footprint contribution.

As a result, all the above-mentioned problems have made it imperative to make an innovation in the relevant technical field.

### SUMMARY

The present invention relates to a method to eliminate the above-mentioned disadvantages and to bring new advantages to the relevant technical field.

One object of the invention is to provide a method that enables the determination of the contents of objects, which are one of the clothing, textile products, garments that do not have a label.

Another object of the invention is to provide a method for proper washing, recycling, dyeing, donation, sale or purchase of objects.

Another object of the invention is to provide a method that enables companies to gain additional carbon credits, leading to the possibility of advanced carbon footprint calculation.

In order to achieve all the objects mentioned above and to be deduced from the detailed description below, the present invention is a method performed by a system with a user terminal consisting of a label sensor that detects the labels of the objects and produces a corresponding label signal, a camera for capturing the images of the objects, and a processor unit that receives the signal from the said camera and label sensor in order to detect the contents of objects, which are clothing, textile products and garments. Accordingly, it comprises the steps of querying whether a label signal is received from the label sensor, extracting content information about the object content from the label signal in case a label signal is received from the label sensor, taking an image of clothing captured from the camera if a label signal is not received from the label sensor, determining a logo in the object image, predicting which brand the determined logo belongs to with a first object recognition model, predicting multiple characteristic features of the object in the image with a second object recognition model, accessing an information server where the object contents of the brands are recorded together with the object characteristic information, determining the object that matches the predicted object characteristic and the predicted brand in the information server, and retrieving the object content. Thus, it is ensured that the content information of unlabeled, illegible, damaged clothing is obtained.

The feature of a possible embodiment of the invention is that it comprises the steps of querying whether the image of the object captured is appropriate and displaying instructions on the user interface for the user to view objects from different angles. Thus, appropriate images are taken.

The feature of another possible embodiment of the invention is that said information server is a web page belonging to the brand; that it comprises the process steps of:
identifying keywords corresponding to the predicted object characteristics from a keyword database;
accessing the brand's web page;
performing the filtering process by entering the specified keywords into a filtering module of the brand's web page;
determining the similarity rate of the results similar to the object with the highest similarity rate by means of a correlation model that determines the similarity of the images of the results obtained in the filtering process to the object image;
presenting the determined results to the user from the user interface;
retrieving the object content associated with the result selected by the user from the web page. Thus, even if there is no database specially designed for this purpose, it is ensured that the content information of the objects is determined.

The feature of another possible embodiment of the invention is that a recycling facility suitable for the content of the object is determined and a request is sent to the designated recycling facility. Thus, it is ensured that proper recycling is carried out.

The feature of another possible embodiment of the invention is that it comprises the steps of sending the object content to a washing device included in the said system, which selects one of the pre-registered washing programs in a washing program selection model according to the object content information it receives, selecting a washing program by the washing device by applying the received object contents to the washing program selection model, and starting the selected washing program. In this way, the washing program suitable for the object is automatically adjusted.

The feature of another possible embodiment of the invention is that it comprises the steps of sending the clothing content and object characteristic information to a dyeing device included in the said system, which selects one of the pre-registered dyeing programs in a dyeing program selection model according to the object content and object characteristic information it receives, selecting a dyeing program by the dyeing device by applying the received clothing contents to the dyeing program selection model, and starting the selected dyeing program.

The feature of another possible embodiment of the invention is that it involves the step of purchasing from a purchasing server using the object content, the object's brand and the object characteristics.

The feature of another possible embodiment of the invention is that it involves the step of creating a record of the product sold from a sales server using the object content, the object's brand and the object characteristics.

The feature of another possible embodiment of the invention is that it involves the steps of providing access to a commercial online platform where users sell and resell their used or second-hand items, providing access to an online platform that connects users with recycling centers to enable them to send their used or second-hand items to recycling centers, providing access to an online platform that connects users with charities to enable them to donate their used or second-hand items to charities, enabling online access for charities by enabling charities to offer or display used or second-hand items on an online platform accessible to users, and offering a rewards program that allows users to gain reward points when they donate or recycle used or second-hand items.

### BRIEF DESCRIPTION OF THE DRAWINGS

FIG. 1 shows a representative view of the system.

FIG. 2 shows a representative view of the contribution of an embodiment of the system to the carbon footprint calculation.

### DETAILED DESCRIPTION OF THE EMBODIMENTS

In this detailed description, the subject of the invention is explained only with examples that will not create any limiting effect on a better understanding of the subject.

The invention is a system and method that enables the detection of object contents, which are one of the clothing, textile products and garments. After the contents of the clothing are determined, it can be ensured that they are properly recycled, washed, dyed, purchased or sold.

In a possible embodiment of the invention, the object is clothing.

In another possible embodiment of the invention, the said object is a garment. These can include shoes, bags, hats, etc.

In a possible embodiment, clothing is a textile product. For example, curtains, carpets, fabrics, etc. can be mentioned.

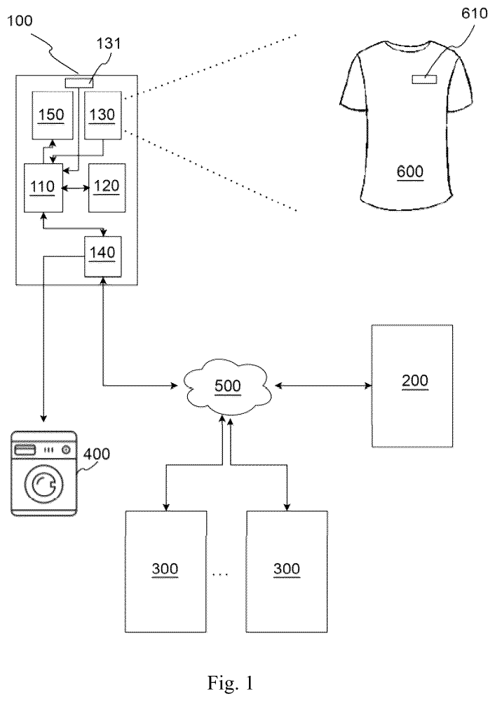

With reference to FIG. 1, the system performing the method of the present invention comprises a user terminal (100). The said user terminal (100) comprises a label sensor (131). The label sensor (131) is suitable for detecting an object label. The label sensor (131) can be similar to an RFID reader, QR or barcode reader and can read labels with barcode, RFID, QR features. The labels of the objects are also arranged in such a way as to provide information about the content of the object after it is read. The user terminal (100) can comprise a camera (130) to capture the images of objects (600). The user terminal (100) contains a processor unit (110) and a memory unit (120) with which the processor unit (110) is associated to read and write data. In the memory unit (120), there may be software consisting of command lines executed by the processor unit (110), in which the necessary steps are applied for the realization of the method of the present invention. The processor unit (110) is connected to the label sensor (131) and the camera (130). The user terminal (100) comprises a communication unit (140). The communication unit (140) enables the processor unit (110) to exchange data by connecting to a communication network (500) such as the Internet. The user terminal (100) can also comprise a user interface (150). The user interface (150) enables the user to transmit commands and data to the processor unit (110) and to present the data to the user. The user interface (150) is, for example, a touch-sensitive display. The user terminal (100) can be, for example, a smart phone, tablet computer, etc. The processor unit (110) is able to detect the object content according to the signal it receives from the label sensor (131).

The content of the object mentioned here can be, for example, what materials the object (600) contains, the amount of material, etc.

If the processor unit (110) does not receive a signal from the label sensor (131), it detects a logo (610) in the images it receives from the camera (130). An artificial intelligence model can be used for this purpose. The logo (610) can be positioned in various parts of the object (600) according to the type of object (600).

The processor unit (110) then runs a first object recognition model to determine which brand the detected logo (610) belongs to. The first object recognition model can be an artificial intelligence model trained on various logo (610) images. It predicts which brand the logos (610) in the images belong to.

The processor unit (110) determines the object characteristics by means of a second object recognition model. The said object recognition tool is trained on object images and trained on the characteristics of these object images. In the case where the object is a clothing, the characteristics of the object may be physical characteristics such as, for example, gender (male, female, unisex, child); season (summer, autumn, spring, four seasons); occasion (casual, formal, sports, work, party, sleep); type (top, bottom, outerwear, accessory); specific type (shirt, trousers, jacket, hat, etc.); texture (plain, ribbed, knitted, etc.); cut (slim, regular, loose, etc.); style (vintage, bohemian, minimalist, etc.); color (red, blue, green, etc.); pattern (plain, striped, plaid, etc.); type of closure (zipper, button, etc.); pockets (front pockets, back pockets, etc.); sleeve length (sleeveless, short-sleeved, etc.); type of collar (V-neck, scoop neck, etc.); ornaments (embroidery, sequins, etc.); length (short, knee-length, etc.). These features are provided for illustrative purposes only and do not constitute a limiting effect.

For example, when the characteristics of a clothing are determined by the second object recognition model, information such as the following can be obtained:

Gender: Male; Season: Winter; Occasion: Casual; Type: Outerwear; Specific Type: Jacket; Texture: Quilted; Cut: Regular; Style: Sport; Color: Blue; Pattern: Plain; Type of Closure: Zipper; Pockets: Front pockets; Sleeve Length: Long sleeved; Type of Collar: Collared; Ornaments: No; Length: Hip length.

The system comprises an information server (200). The information server (200) comprises the objects (600) of the brands and the characteristics of the objects associated with them and the content information of these objects. The processor unit (110) sends the object characteristics to the relevant information server (200) and receives the object content information. Object content information may comprise the materials from which the object is manufactured, their percentages, washing instructions, etc. Thus, the content information of the objects whose labels cannot be accessed can be obtained. With this information, a content-specific recycling plan, washing plan, dyeing plan, sales or purchase plan can be performed.

In a possible embodiment of the invention, when the logo (610) cannot be detected or the object image is determined to be inappropriate, the instructions regarding the desired state of the image are displayed in the user interface (150). In a possible embodiment, guides are added to the image seen on the camera (130) and the object (600) is placed in accordance with the guides.

In a possible embodiment, the system comprises a recycling facility server (300). The content information is sent to the recycling facility server (300). Thus, the recycling facility suitable for the content of the object can be selected and a recycling plan can be performed.

In a possible embodiment, the information server (200) is a web page belonging to the brand, where products can be filtered. The processor unit (110) determines the keywords corresponding to the predicted object characteristics from a keyword database, accesses the web page and performs the filtering process by entering the specified keywords in a filtering module of the web page. By means of a correlation model that determines the similarity of the images of the results obtained in the filtering process to the object image, the results with the highest similarity rate are determined from the results similar to the object (600) captured, the determined results are presented to the user from the user interface (150), and the object content associated with the result selected by the user is retrieved from the web page.

In a possible embodiment, the system comprises a washing device (400). The washing device (400) is capable of performing predetermined washing programs. It can receive signals from the processor unit (110). It comprises a washing program selection model that predicts the appropriate washing program when it applies the clothing information it receives from the processor unit (110) as input. When more than one object information is entered, a washing program suitable for a large number of clothing (600) is selected.

In a possible embodiment, the system comprises a dyeing machine (not shown in the drawings). The dyeing machine is capable of performing predetermined dyeing programs. It can receive signals from the processor unit (110). It comprises a dyeing program selection model that predicts the appropriate dyeing program when it applies the clothing information it receives from the processor unit (110) as input. In this way, it is ensured that the objects (600) are brought back to their original color.

The system comprises a purchasing server (not shown in the drawings). In a possible embodiment, the processor unit (110) performs the purchase process from a purchasing server using the object's brand and object characteristics. Purchasing the same product once again is easily provided.

The system comprises a sales server (not shown in the drawings). In a possible embodiment, the processor unit (110) enables the creation of a sales record on a sales server using the object's brand, object characteristics and object content information.

In an embodiment, the objects from which the object content is obtained are recorded in the memory unit (120) by the processor unit (110) and the objects (600) owned by the user are stored in an account. With this information, sales and purchases can be made, donations or recycling can be done, and the washing/dyeing program can be determined.

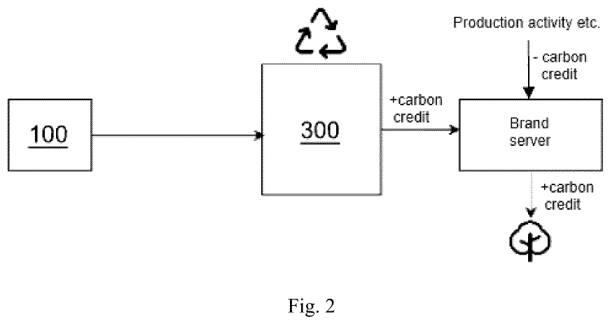

With reference to FIG. 2, the product content information obtained and the information about the recycled objects (600) are sent to the brand servers and additional carbon footprint calculations are provided. The system provides incentives for companies to participate in the system to increase their carbon credits and to provide clothing content information to the system. Thanks to the system, companies can gain additional carbon credits and reduce their carbon footprint following the recycling of the products they produce.

In a possible embodiment of the invention, the system calculates the carbon footprint using content information. The said carbon footprint is obtained from information such as the content of the object, its weight, etc. In case of recycling, its contribution to the carbon footprint is calculated. The calculated carbon footprint can be sent to the brand server. Thus, it is possible for companies to gain additional carbon footprint credits.

For example, the recycling center can send signals to the sorting machines, sorting all cotton garments in one group, all polyester-based garments in another group, and so on. This facilitates the sorting of objects (600) and thus simplifies the recycling process of used or second-hand clothing. As a result, more used or second-hand clothing is being recycled.

In addition, a washing apparatus (not shown in the drawings) is provided that takes the data as input and applies cleaning in a possible embodiment. These facilities or compartments or modules or embodiments include, but are not limited to, an ultraviolet (UV) disinfection/sterilization lamp or device, a laser cleaning device, a gaseous or aqueous ozone production device, a carbon filter or filters, an odor-inducing device, a vibration or agitation or ultrasonic vibration device or capability, or surface roughness.

In this embodiment, it varies in size and shape. The shape can be round or conical or cylindrical or tubular or any other shape, and the size may vary, but on average it can be 30 cm long.

The device in this embodiment may need to be placed in a container with or without water to clean any clothing or textiles or other washable products.

In a possible embodiment, an autonomous washing system (not shown in the drawings) that receives content data comprises methods, processes, software, hardware, apparatus that cleans textile or clothing products or any washable or cleanable product without the need for wash cycles.

This embodiment comprises multiple compartments, including but not limited to camera (130) or sensor compartments, a sorting/cleaning compartment, storage compartments, and data transfer compartments.

This embodiment comprises camera (130) or sensor compartments 1) at door or entrance access to the sorting/cleaning compartment and 2) inside the same sorting/cleaning compartment. The camera (130) or sensor compartments comprises cameras (130) or detectors or sensors to read, scan or capture images of clothing or textiles or washable or cleanable products that are discarded or left in or stored in the sorting/storage compartment.

This embodiment comprises at least one sorting/cleaning compartment where, as described above, used or dirty clothing or textiles, or any washable or cleanable product, may be placed or inserted into or stored within this device until the start of the cleaning period, which can be manually initiated via the built-in rotation interface or initiated by the built-in program.

As described above, the device comprises storage compartments, each of which is dedicated to a specific type of textile fabric material. Thus, at least there are compartments for cotton, polyester, silk, wool, denim, delicates, colors, etc.

As described above, the device contains cameras (130) or sensors or detectors that identify the type of fabric materials of garments or textiles or other washable or cleanable products. In addition, the built-in Artificial Intelligence processes the captured image with reference to the Data Bank to identify products or fabric material types and determine the optimal cleaning conditions within the sorting/cleaning compartment. In addition, the device is able to send instruction signals or data to the data transfer compartments in the EM5 to help identify products and determine optimal cleaning conditions within the sorting/cleaning compartment.

As described above, the device sorts clothing or textiles or other washable or cleanable products into the corresponding storage compartments after they have been identified by the camera (130)/sensor compartments or the built-in Artificial Intelligence, or after the textiles have been identified. The products mentioned above are sorted by a variety of methods, including, but not limited to, gravitational force, suction pulling, pressure pulling, or other methods or technologies used to sort or pull/push products into compartments. The products mentioned above remain in the storage compartments until the cleaning program is started manually or by the built-in program.

As described above, the device comprises at least one of the following: UV disinfection/sterilization lamp or device, laser cleaning device or capability, carbon filters, vapor generating device or facility, or odor-producing device or facility.

The dyeing device embodiment comprises methods, processes, software, hardware, apparatus that redye garments or textiles or any purchased or manufactured or natural product by applying one dye or more than one dye.

The dyeing device consists of at least one compartment, a tray, product positioning handles, dye storage compartments and dye application apparatus. The dyeing device also comprises camera (130) or sensor compartments to capture the image of the products placed on the tray. The dyeing device also comprises a data transfer device to send and receive data to/from the Data Bank.

As described above, the dyeing device redyes garments or textiles, or products that can be purchased or manufactured or natural, by applying the original dye colors. The original dye color is stored in the Data Bank and applied by the dye application apparatus using the dye stored in the dye storage compartments.

Alternatively, the dyeing device identifies the dye color of the garment or textile, or any purchasable or manufactured or natural product, by capturing an image of the aforementioned product and then comparing it with the image of the same time stored in the Data Bank. The built-in Artificial Intelligence then calculates the percentage or amount of the dye difference between the 2 pictures and then sends instruction signals or data to the dye application apparatus to apply the amount of the dye difference.

The protection scope of the invention is specified in the appended claims and cannot be limited to what is described in this detailed description for illustrative purposes. It is clear that a person skilled in the art can present similar structures in the light of the above, without leaving the main theme of the invention.

### REFERENCE NUMBERS IN THE DRAWINGS

100 User terminal
110 Processor unit
120 Memory unit
130 Camera
131 Label sensor
140 Communication unit
150 User interface
200 Information server
300 Recycling facility server
400 Cleaning device
500 Communication network
600 Object
610 Logo

What is claimed is:

1. A method performed by a system with a user terminal consisting of a label sensor detecting labels of objects and producing-produces a corresponding label signal, a camera capturing the images of the objects, and a processor unit receiving the corresponding label signal from the camera and the label sensor in order to detect contents of the objects, wherein the contents of the objects are clothing, textile products and garments, and the method comprises steps of:
querying whether the corresponding label signal is received from the label sensor;
extracting content information of the contents of the objects from the corresponding label signal in case the corresponding label signal is received from the label sensor;
taking an image of clothing captured from the camera if the corresponding label signal is not received from the label sensor;
determining a logo in an object image;
predicting which brand the logo belongs to with a first object recognition model;
predicting multiple characteristic features of each of the objects in the object image with a second object recognition model;
accessing an information server, wherein object contents of brands are recorded in the information server together with object characteristic information;
determining an object matching predicted object characteristic and predicted brand in the information server, and retrieving the object contents.

2. The method according to claim 1, wherein the method further comprises steps of:
querying whether the images of the objects captured are appropriate;
displaying instructions on a user interface for a user to view the objects from different angles.

3. The method according to claim 1, wherein the information server is a web page belonging to the brand; and the method comprises steps of:
identifying keywords corresponding to the predicted object characteristic from a keyword database;
accessing the web page of the brand;
performing a filtering process by entering the keywords into a filtering module of the web page of the brand;
determining a similarity rate of results similar to the objects captured with a highest similarity rate by a correlation model determining a similarity of images of the results obtained in the filtering process to the object image;
presenting the results to a user from a user interface;
retrieving the object contents associated with the results selected by the user from the web page.

4. The method according to claim 1, wherein a recycling facility suitable for the contents of the objects is determined and a request is sent to the recycling facility.

5. The method according to claim 1, wherein the method further omprises steps of:
sending the object contents to a washing device included in the system, wherein the washing device selects one of pre-registered washing programs in a washing program selection model according received object content information;
selecting a washing program by the washing device by applying the received object content information to the washing program selection model;
starting the washing program.

6. The method according to claim 1, wherein the method further comprises steps of:
sending the clothing content and the object characteristic information to a dyeing device included in the system, wherein the dyeing device selects one of pre-registered dyeing programs in a dyeing program selection model according to the object contents and the object characteristic information received;
selecting a dyeing program by the dyeing device by applying the clothing content to the dyeing program selection model;
starting the dyeing program.

7. The method according to claim 1, wherein the method further comprises a step of:
purchasing from a purchasing server using the object contents, the brand and the predicted object characteristic.

8. The method according to claim 1, wherein the method further comprises a step of:
creating a record of a product sold from a sales server using the object contents, the brand and the predicted object characteristic.

9. The method according to claim 1, wherein the method further comprises steps of providing access to a commercial online platform where users sell and resell used or second-hand items, providing access to an online platform connecting the users with recycling centers to enable the users to send the used or second-hand items to the recycling centers, providing access to an online platform connecting the users with charities to enable the users to donate the used or second-hand items to the charities, enabling online access for the charities by enabling the charities to offer or display the used or second-hand items on an online platform accessible to the users; and
offering a rewards program allowing the users to gain reward points when the users donate or recycle the used or second-hand items.

10. The method according to claim 1, wherein if the objects are sent for recycling, carbon footprint is calculated according to object content information and the carbon footprint is sent to a brand server.

11. A system for applying the method according to claim 1.
